(19) United States
(12) Patent Application Publication
(10) Pub. No.: US 2008/0312379 A1
(43) Pub. Date: Dec. 18, 2008

(54) Method for Compounding Polycondesates

(75) Inventors: Dietrich Scherzer, Neustadt (DE); Andreas Eipper, Ludwigshafen (DE); Carsten Weiss, Singapore (SG); Motonori Yamamoto, Mannheim (DE); Gabriel Skupin, Speyer (DE); Uwe Witt, Mutterstadt (DE)

Correspondence Address: CONNOLLY BOVE LODGE & HUTZ LLP, 1875 EYE STREET, N.W., SUITE 1100, WASHINGTON, DC, 20006, US

(73) Assignee: BASF Aktiengesellschaft, Ludwigshafen (DE)

(21) Appl. No.: 11/815,582

(22) PCT Filed: Feb. 15, 2006
(86) PCT No.: PCT/EP06/50966

§ 371 Date: Aug. 6, 2007

(30) Foreign Application Priority Data
Feb. 17, 2005 (DE) 10 2005 007 479.0

(51) Int. Cl. C08G 63/00; C08F 8/00; C08G 69/00; C08F 20/10; C08F 20/54; C08G 64/00

(52) U.S. Cl. 525/178; 525/419; 525/418; 525/415; 525/386; 525/383; 525/370; 525/340

(57) ABSTRACT

The invention relates to a process for compounding polycondensates selected from the group consisting of polyamide, polyester and polycarbonate, in the presence of an epoxy-containing styrene and/or (meth)acrylic monomer, of a bisphenol A epoxide or of an epoxy-containing natural oil or fatty acid ester, which comprises carrying out the compounding at temperatures less than/equal to 220° C. and in the presence of an activator selected from the group consisting of: zinc, titanium compound and C₁-C₁₂-alkyltriphenylphosphonium halide.

The present invention relates to an improved process for compounding homo- or copolymeric polycondensates selected from the group consisting of polyamide, polyester and polycarbonate, in the presence of an epoxy-containing styrene and/or (meth)acrylic monomer or of an epoxy-containing natural oil or fatty acid ester.

Processes for compounding PET in the presence of an epoxy-containing styrene and/or (meth)acrylic monomer are known, for example, from US 2004/0147678. Typical processing temperatures for PET are from 240 to 300° C.

However, numerous polymers have to be compounded at lower temperatures. Especially biopolymers, for example polyhydroxyalkanoates, decompose at temperatures which are distinctly above 200° C. Other biopolymers decompose noticeably at temperatures above 200° C. The melt volume flow rate (MVR) rises. The highly viscous melts can no longer be processed for certain applications, for example blow-molding.

It was an object of the present invention to find a process which does not have the disadvantages of the process known from US 2004/0147678.

Surprisingly, this object is achieved by adding to the melt a zinc compound, titanium compound or a C₁-C₁₂-alkyltriphenylphosphonium halide. The epoxy-containing compatiblizer is activated by the abovementioned compounds and can counteract chain degradation even at temperatures below 220° C.

In principle, the process is suitable for compounding polycondensates selected from the group consisting of polyamides, polyesters and polycarbonates.

In particular, the process according to the invention is suitable for preparing biodegradable homo- or copolyesters selected from the group consisting of polylactide, polycaprolactone, polyhydroxyalkanoates and polyesters composed of aliphatic and/or aromatic dicarboxylic acids and aliphatic diols.

Also useful are all polyesters based on aliphatic and aromatic dicarboxylic acids and aliphatic dihydroxyl compound, known as partly aromatic polyesters. It will be appreciated that mixtures of a plurality of such polyesters are also suitable as the polycondensate.

According to the invention, partly aromatic polyesters should also be understood to mean polyester derivatives such as polyether esters, polyester amides or polyether ester amides. The suitable partly aromatic polyesters include linear, non-chain-extended polyesters (WO 92/09654). Preference is given to chain-extended and/or branched partly aromatic polyesters. The latter are known from the documents WO 96/15173 to 15176, 21689 to 21692, 25446, 25448 and WO 98/12242, which are exclusively incorporated by reference. Mixtures of different partly aromatic polyesters are equally useful. In particular, partly aromatic polyesters include products such as Ecoflex® (BASF Aktiengesellschaft) and Eastar® Bio (Novamont).

The particularly preferred partly aromatic polyesters include polyesters which comprise, as essential components,
A) an acid component composed of
a1) from 30 to 99 mol % of at least one aliphatic or of at least one cycloaliphatic dicarboxylic acid or their ester-forming derivatives or mixtures thereof,
a2) from 1 to 70 mol % of at least one aromatic dicarboxylic acid or its ester-forming derivative or mixtures thereof and
a3) from 0 to 5 mol % of a sulfonate-containing compound,
B) a diol component selected from at least one C₂— to —C₁₋₂-alkanediol and at least one C₅— to —C₁₋₁₀-cycloalkanediol or mixtures thereof
   and, if desired, additionally one or more components selected from
C) a component selected from
c1) dihydroxyl compound which comprises at least one ether function and is of the formula I

HO—[(CH₂)ₙ—O]ₘ—H (I)

in which n is 2, 3 or 4 and m is an integer from 2 to 250,
c2) at least one hydroxy carboxylic acid of the formula IIa or IIb

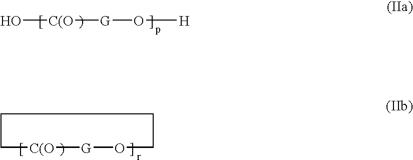

in which p is an integer from 1 to 1500 and r is an integer from 1 to 4, and G is a radical which is selected from the group consisting of phenylene, —(CH₂)_{q}—, where q is an integer from 1 to 5, —C(R)H— and —C(R)HCH₂, where R is methyl or ethyl,
c3) at least one amino-C₂— to —C₁₋₂-alkanol or at least one amino-C₅— to —C₁₋₁₀-cycloalkanol or mixtures thereof,
c4) at least one diamino-C₁- to —C₈-alkane,
c5) at least one 2,2′-bisoxazoline of the general formula III

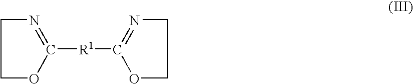

where R¹ is a single bond, a (CH₂)_{z}-alkylene group where z=2, 3 or 4, or a phenylene group,
c6) at least one aminocarboxylic acid selected from the group consisting of the natural amino acids, polyamides obtainable by polycondensation of a dicarboxylic acid having from 4 to 6 carbon atoms and a diamine having from 4 to 10 carbon atoms, compounds of the formulae IVa and IVb

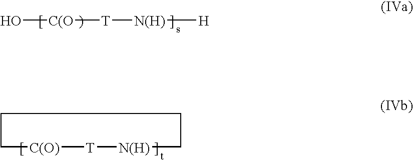

in which s is an integer from 1 to 1500 and t is an integer from 1 to 4, and T is a radical which is selected from the group consisting of phenylene, —(CH₂)ᵤ—, where u is an integer from 1 to 12, —C(R²)H— and —C(R²)HCH₂, where R² is methyl or ethyl,
   and polyoxazolines having the repeat unit V

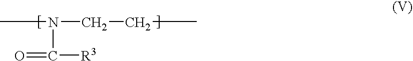

in which R³ is hydrogen, C₁-C₆-alkyl, C₅-C₈-cycloalkyl, phenyl which is unsubstituted or up to trisubstituted by C₁-C₄-alkyl groups, or tetrahydrofuryl,
or mixtures of c1 to c6,
and
D) a component selected from
d1) at least one compound having at least three groups capable of ester formation,
d2) at least one isocyanate,
d3) at least one divinyl ether,
   or mixtures of d1) to d3).

In a preferred embodiment, the acid component A of the partly aromatic polyester comprises from 30 to 70 mol %, in particular from 40 to 60 mol %, of a1, and from 30 to 70 mol %, in particular from 40 to 60 mol %, of a2.

Useful aliphatic acids and the corresponding derivatives a1 are generally those having from 2 to 10 carbon atoms, preferably from 4 to 6 carbon atoms. They may either be linear or branched. The cycloaliphatic dicarboxylic acids which can be used in the context of the present invention are generally those having from 7 to 10 carbon atoms and in particular those having 8 carbon atoms. However, it is also possible in principle to use dicarboxylic acids having a larger number of carbon atoms, for example having up to 30 carbon atoms.

Examples include: malonic acid, succinic acid, glutaric acid, 2-methylglutaric acid, 3-methylglutaric acid, adipic acid, pimelic acid, azelaic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid and 2,5-norbornanedicarboxylic acid.

The likewise usable ester-forming derivatives of the abovementioned aliphatic or cycloaliphatic dicarboxylic acids are in particular the di-C₁- to —C₆— alkyl esters, such as dimethyl, diethyl, di-n-propyl, diisopropyl, di-n-butyl, diisobutyl, di-t-butyl, di-n-pentyl, diisopentyl or di-n-hexyl esters. It is likewise possible to use anhydrides of the dicarboxylic acids.

The dicarboxylic acids or their ester-forming derivatives may be used individually or as a mixture of two or more thereof.

Particular preference is given to using adipic acid, sebacic acid or their particular ester-forming derivatives or mixtures thereof. Particular preference is given to using adipic acid or their ester-forming derivatives, such as alkyl esters thereof or mixtures thereof.

Suitable aromatic dicarboxylic acids a2 are generally those having from 8 to 12 carbon atoms and preferably those having 8 carbon atoms. Examples include terephthalic acid, isophthalic acid, 2,6-naphthoic acid and 1,5-naphthoic acid, and also ester-forming derivatives thereof. Mention should be made in particular of the di-C₁-C₆-alkyl esters, e.g. dimethyl, diethyl, di-n-propyl, diisopropyl, di-n-butyl, diisobutyl, di-t-butyl, di-n-pentyl, diisopentyl or di-n-hexyl ester. The anhydrides of the dicarboxylic acids a2 are equally suitable ester-forming derivatives.

In principle, it is also possible, however, to use aromatic dicarboxylic acids a2 having a larger number of carbon atoms, for example up to 20 carbon atoms.

The aromatic dicarboxylic acids or their ester-forming derivatives a2 may be used individually or as a mixture of two or more thereof. Particular preference is given to using terephthalic acid or ester-forming derivatives thereof, such as dimethyl terephthalate.

The sulfonate-containing compound used is typically an alkali metal or alkaline earth metal salt of a sulfonate-containing dicarboxylic acid or ester-forming derivatives thereof, preferably alkali metal salts of 5-sulfoisophthalic acid or mixtures thereof, more preferably the sodium salt.

In one of the preferred embodiments, the acid component A comprises from 40 to 60 mol % of a1, from 40 to 60 mol % of a2 and from 0 to 2 mol % of a3. In a further preferred embodiment, the acid component A comprises from 40 to 59.9 mol % of a1, from 40 to 59.9 mol % of a2 and from 0.1 to 1 mol % of a3, in particular from 40 to 59.8 mol % of a1, from 40 to 59.8 mol % of a2 and from 0.2 to 0.5 mol % of a3.

In general, the diols B are selected from branched or linear alkanediols having from 2 to 12 carbon atoms, preferably from 4 to 6 carbon atoms, or cycloalkanediols having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, in particular ethylene glycol, 1,3-propane-diol, 1,4-butanediol and 2,2-dimethyl-1,3-propanediol (neopentyl glycol); cyclopentane-diol, 1,4-cyclohexanediol, 1,2-cyclohexanedimethanol, 1,3-cyclohexanedimethanol, 1,4-cyclohexanedimethanol or 2,2,4,4-tetramethyl-1,3-cyclobutanediol. It is also possible to use mixtures of different alkanediols.

Depending on whether an excess of acid or OH end groups is desired, it is possible to use either component A or component B in excess. In a preferred embodiment, the molar ratio of components A to B used is in the range from 0.4:1 to 1.5:1, preferably in the range from 0.6:1 to 1.1:1.

In addition to components A and B, the polyesters on which the inventive polyester mixtures are based may comprise further components.

The dihydroxyl compounds c1 used are preferably diethylene glycol, triethylene glycol, polyethylene glycol, polypropylene glycol and polytetrahydrofuran (polyTHF), more preferably diethylene glycol, triethylene glycol and polyethylene glycol, and it is also possible to use mixtures thereof or compounds which have different variables n (see formula I), for example polyethylene glycol which comprises propylene units (n=3), obtainable, for example, by polymerization, by methods known per se, first of ethylene oxide and then of propylene oxide, more preferably a polymer based on polyethylene glycol with different variables n, where units formed from ethylene oxide predominate. The molecular weight (Mₙ) of the polyethylene glycol is generally selected within the range from 250 to 8000 g/mol, preferably from 600 to 3000 g/mol.

In one of the preferred embodiments, it is possible to use for the preparation of the partly aromatic polyesters, for example, from 15 to 98 mol %, preferably from 60 to 99.5 mol %, of the diols B, and from 0.2 to 85 mol %, preferably from 0.5 to 30 mol %, of the dihydroxyl compounds c1, based on the molar amount of B and c1.

In a preferred embodiment, the hydroxycarboxylic acid c2) used is: glycolic acid, D-, L- or D,L-lactic acid, 6-hydroxyhexanoic acid, their cyclic derivatives such as glycolide (1,4-dioxane-2,5-dione), D- or L-dilactide (3,6-dimethyl-1,4-dioxane-2,5-dione), p-hydroxybenzoic acid, or else their oligomers and 3-polyhydroxyalkanoates such as polyhydroxybutyric acid, polyhydroxyvaleric acid, polylactide (obtainable, for example, as EcoPLA® 2000D (Cargill)), or else a mixture of 3-polyhydroxybutyric acid and polyhydroxyvaleric acid (the latter being obtainable as Biopol® from Zeneca), or else other copolymers of 3-polyhydroxybutyric acid and polyhydroxyalkanoic acids such as polyhydroxyhexanoic acid or polyhydroxyoctanoic acid; for the preparation of partly aromatic polyesters, particular preference is given to the low molecular weight and cyclic derivatives thereof.

The hydroxycarboxylic acids may be used, for example, in amounts of from 0.01 to 50% by weight, preferably from 0.1 to 40% by weight, based on the amount of A and B.

The amino-C₂-C₁₂-alkanol or amino-C₅-C₁₀-cycloalkanol used (component c3), which is also intended to include 4-aminomethylcyclohexanemethanol, is preferably amino-C₂-C₆-alkanols such as 2-aminoethanol, 3-aminopropanol, 4-aminobutanol, 5-amino-pentanol or 6-aminohexanol, or else amino-C₅-C₆-cycloalkanols such as aminocyclo-pentanol and aminocyclohexanol, or mixtures thereof.

The diamino-C₁-C₈-alkane (component c4) used is preferably diamino-C₄-C₆-alkanes such as 1,4-diaminobutane, 1,5-diaminopentane or 1,6-diaminohexane (hexa-methylenediamine, “HMD”).

In a preferred embodiment for the preparation of the partly aromatic polyesters, it is possible to use from 0.5 to 99.5 mol %, preferably from 0.5 to 50 mol %, of c3, based on the molar amount of B, and from 0 to 50 mol %, preferably from 0 to 35 mol %, of c4, based on the molar amount of B.

The 2,2′-bisoxazolines c5 of the general formula III are generally obtainable via the process of Angew. Chem. Int. Edit., Vol. 11 (1972), pp. 287-288. Particularly preferred bisoxazolines are those in which R¹ is a single bond, a (CH₂)_{z}-alkylene group where z 2, 3 or 4, for example methylene, ethane-1,2-diyl, propane-1,3-diyl or propane-1,2-diyl, or a phenylene group. Particularly preferred bisoxazolines include 2,2′-bis(2-oxazoline), bis(2-oxazolinyl)methane, 1,2-bis(2-oxazolinyl)ethane, 1,3-bis(2-oxazolinyl)propane and 1,4-bis(2-oxazolinyl)butane, in particular 1,4-bis(2-oxazolinyl)benzene, 1,2-bis(2-oxazolinyl)benzene or 1,3-bis(2-oxazolinyl)benzene.

For the preparation of the partly aromatic polyesters, it is possible to use, for example, from 70 to 98 mol % of B, up to 30 mol % of c3 and from 0.5 to 30 mol % of c4 and from 0.5 to 30 mol % of c5, based in each case on the sum of the molar amounts of components B, c3, c4 and c5. In another preferred embodiment, it is possible to use from 0.1 to 5% by weight, preferably from 0.2 to 4% by weight, of c5, based on the total weight of A and B.

The component c6 used may be naturally occurring aminocarboxylic acids. These include valine, leucine, isoleucine, threonine, methionine, phenylalanine, tryptophan, lysine, alanine, arginine, aspartamic acid, cysteine, glutamic acid, glycine, histidine, proline, serine, tyrosine, asparagine and glutamine.

Preferred aminocarboxylic acids of the general formulae IVa and IVb are those in which s is an integer from 1 to 1000 and t is an integer from 1 to 4, preferably 1 or 2, and T is selected from the group consisting of phenylene and —(CH₂)ᵤ— where u is 1, 5 or 12.

c6 may also be a polyoxazoline of the general formula V. However, c6 may also be a mixture of different aminocarboxylic acids and/or polyoxazolines.

In a preferred embodiment, c6 may be used in amounts of from 0.01 to 50% by weight, preferably from 0.1 to 40% by weight, based on the total amount of components A and B.

Other components which may optionally be used for preparing the partly aromatic polyesters include compounds d1 which comprise at least three groups capable of ester formation.

The compounds d1 preferably comprise from three to ten functional groups which are capable of forming ester bonds. Particularly preferred compounds d1 have from three to six functional groups of this type in the molecule, in particular from three to six hydroxyl groups and/or carboxyl groups. Examples include:

tartaric acid, citric acid, maleic acid;
trimethylolpropane, trimethylolethane;
pentaerythritol;
polyethertriols;
glycerol;
trimesic acid;
trimellitic acid, trimellitic anhydride;
pyromellitic acid, pyromellitic dianhydride, and
hydroxyisophthalic acid.

The compounds d1 are generally used in amounts of from 0.01 to 15 mol %, preferably from 0.05 to 10 mol %, more preferably from 0.1 to 4 mol %, based on component A.

Components d2 used are one isocyanate or a mixture of different isocyanates. It is possible to use aromatic or aliphatic diisocyanates. However, higher-functionality isocyanates may also be used.

In the context of the present invention, aromatic diisocyanate d2 is in particular

tolylene 2,4-diisocyanate, tolylene 2,6-diisocyanate, diphenylmethane 2,2′-diiso-cyanate, diphenylmethane 2,4′-diisocyanate, diphenylmethane 4,4′-diisocyanate, naphthylene 1,5-diisocyanate or xylylene diisocyanate.

Among these, particular preference is given to diphenylmethane 2,2′-, 2,4′- and 4,4′-diisocyanate as component d2. The latter diisocyanates are generally used as a mixture.

A three-ring isocyanate d2 which may also be used is tri(4-isocyanophenyl)methane. The multiring aromatic diisocyanates are obtained, for example, in the course of the preparation of one- or two-ring diisocyanates.

Component d2 may also comprise minor amounts, for example up to 5% by weight, based on the total weight of component d2, of uretdione groups, for example for capping the isocyanate groups.

In the context of the present invention, an aliphatic diisocyanate d2 is in particular linear or branched alkylene diisocyanates or cycloalkylene diisocyanates having from 2 to 20 carbon atoms, preferably from 3 to 12 carbon atoms, for example hexamethylene 1,6-diisocyanate, isophorone diisocyanate, or methylenebis(4-isocyanatocyclohexane). Particularly preferred aliphatic diisocyanates d2 are hexamethylene 1,6-diisocyanate and isophorone diisocyanate.

The preferred isocyanurates include the aliphatic isocyanurates which derive from alkylene diisocyanates or cycloalkylene diisocyanates having from 2 to 20 carbon atoms, preferably from 3 to 12 carbon atoms, for example isophorone diisocyanate or methylenebis(4-isocyanatocyclohexane). The alkylene diisocyanates may be either linear or branched. Particular preference is given to isocyanurates which are based on n-hexamethylene diisocyanate, for example cyclic trimers, pentamers or higher oligomers of n-hexamethylene diisocyanate.

In general, component d2 is used in amounts of from 0.01 to 5 mol %, preferably from 0.05 to 4 mol %, more preferably from 0.1 to 4 mol %, based on the total of the molar amounts of A and B.

The divinyl ethers d3 used can generally be any of the customary and commercially available divinyl ethers. Preference is given to using 1,4-butanediol divinyl ethers, 1,6-hexanediol divinyl ethers or 1,4-cyclohexanedimethanol divinyl ethers, or mixtures thereof.

The divinyl ethers are used preferably in amounts of from 0.01 to 5% by weight, in particular from 0.2 to 4% by weight, based on the total weight of A and B.

Examples of preferred partly aromatic polyesters are based on the following components

### A, B, d1

### A, B, d2

A, B, d1, d2

### A, B, d3

### A, B, c1

A, B, c1, d3
A, B, c3, c4
A, B, c3, c4, c5
A, B, d1, c3, c5
A, B, c3, d3
A, B, c3, d1
A, B, c1, c3, d3

### A, B, c2

Among these, particular preference is given to partly aromatic polyesters which are based on A, B and d1, or A, B and d2, or A, B, d1 and d2. In another preferred embodiment, the partly aromatic polyesters are based on A, B, c3, c4 and c5 or A, B, d1, c3 and c5.

The partly aromatic polyesters mentioned and the inventive polyester mixtures are generally biodegradable.

In the context of the present invention, a substance or a substance mixture has the feature of “biodegradability” when this substance or the substance mixture has a percentage degree of biodegradation of at least 60% in at least one of the three processes defined in DIN V 54900-2 (preliminary standard, as at September 1998).

In general, the biodegradability leads to the polyesters or polyester mixtures breaking down within an appropriate and demonstrable period. The degradation may be effected enzymatically, hydrolytically, oxidatively, and/or by the action of electromagnetic radiation, for example UV radiation, and is usually predominantly caused by the action of microorganisms such as bacteria, yeasts, fungi and algae. The biodegradability can be quantified, for example, by mixing polyester with compost and storing it for a certain time. For example, according to DIN EN 13432 or DIN V 54900-2, Method 3, CO₂-free air is passed through ripened compost during the composting process and the compost is subjected to a defined temperature profile. In this case, biodegradability is determined via the ratio of the net amount of CO₂ liberated from the sample (after deducting the amount of CO₂ liberated by the compost without the sample) to the maximum possible amount of CO₂ liberated by the sample (calculated from the carbon content of the sample), this ratio being defined as the percentage biodegradability. Even after a few days of composting, biodegradable polyesters or biodegradable polyester mixtures generally show distinct signs of degradation, such as fungal growth, cracking, and perforation.

Other methods of determining biodegradability are described, for example, in ASTM D 5338 and ASTM D 6400.

The preparation of the partly aromatic polyesters is known per se or can be effected by methods known per se.

The preferred partly aromatic polyesters are characterized by a molecular weight (Mₙ) in the range from 1000 to 100 000 g/mol, in particular in the range from 9000 to 75 000 g/mol, preferably in the range from 10 000 to 50 000 g/mol, and by a melting point in the range from 60 to 170° C., preferably in the range from 80 to 150° C.

The partly aromatic polyesters mentioned may have hydroxyl and/or carboxyl end groups in any desired ratio. The partly aromatic polyesters mentioned may also be end group-modified. For example, OH end groups may be acid-modified by reaction with phthalic acid, phthalic anhydride, trimellitic acid, trimellitic anhydride, pyromellitic acid or pyromellitic anhydride.

Suitable polycondensates are preferably also the following biodegradable polyester mixtures homo- or copolyesters selected from the group consisting of polylactide, polycaprolactone, polyhydroxyalkanoates and polyesters of aliphatic dicarboxylic acids and aliphatic diols.

Preferred polycondensates are also polylactide (PLA) and polyhydroxyalkanoates, and here in particular polyhydroxybutyrate (PHB) and polyhydroxybutyrate covalerate (PHBV). Especially comprised are products such as NatureWorks® (polylactide from Cargill Dow), Biocycle® (polyhydroxybutyrate from PHB Ind.); Enmat® (polyhydroxybutyrate covalerate from Tianan).

Preferred compatibilizers are, for example, epoxy-containing styrene and/or (meth)acrylic monomer. In general, the compounds have two or more epoxy groups in the molecule. Especially suitable are oligomeric or polymeric, epoxidized compounds, for example di- or polyglycidyl esters of di- or polycarboxylic acids, or di- or polyglycidyl ethers of di- or polyols, or copolymers of styrene and glycidyl(meth)acrylates, as are sold, for example, by Johnson Polymers under the brand Joncryl® ADR 4367 or Joncryl® ADR 4368, or else the glycidyl ethers of bisphenol A, as are sold, for example, as Epikote® 828 by Resolution Performance Products.

Further preferred compatibilizers are compounds which comprise at least one carbon-carbon double or triple bond and at least one epoxy group in the molecule. Especially suitable are glycidyl acrylate and glycidyl methacrylate.

Preference is also given to compatibilizers which are composed of epoxy-containing (epoxidized) natural oils or fatty acid esters. Natural oils are understood, for example, to be olive oil, linseed oil, soybean oil, palm oil, peanut oil, coconut oil, seaweed oil, fish oil or a mixture of these compounds. Especially preferred are epoxidized soybean oil (e.g. Merginat® ESBO from Hobum, Hamburg, or Edenol® B 316 from Cognis, Dusseldorf) or epoxidized linseed oil (e.g. Merginat® ELO in Hobum, Hamburg).

The process according to the invention is preferentially suitable for preparing biodegradable polyester mixtures comprising, for example, Ecoflex® as component i and, for example, Biocycle®, NatureWorks®, Biopol® or Enmat® as component ii. Typically, these mixtures comprise from 5 to 90% by weight, preferably from 10 to 70% by weight, more preferably from 15 to 60% by weight, in particular from 20 to 50% by weight, of component i, and from 10 to 95% by weight, preferably from 30 to 90% by weight, more preferably from 40 to 85% by weight, most preferably from 50 to 80% by weight, of component ii, the percentages by weight each being based on the total weight of components i to ii and together adding up to 100% by weight.

For the production of films, the bubble stability is of great significance. It has now been found that mixtures in which component i forms a continuous phase and component ii is embedded into this phase in separate regions have good bubble stability. So that component i forms a continuous phase, the mixtures generally have more than 45% by weight, preferably more than 50% by weight, of component i, based in each case on the total weight of components i and ii (the polycondensate).

The process according to the invention is additionally typically carried out in the presence of from 0.1 to 5% by weight, preferably from 0.1 to 2% by weight, more preferably from 0.3 to 1% by weight, of compatibilizer, the percentages by weight each being based on the total weight of polycondensate.

Activators in the context of the process according to the invention are zinc compounds, titanium compounds or C₁-C₁₂-alkyltriphenylphosphonium halides. Useful activators are in particular zinc stearate, tetra-C₁-C₆-alkyl o-titanate, for example tetrabutyl o-titanate, or ethyltriphenylphosphonium bromide.

The activators are used in concentrations of from 0.1 to 10% by weight, preferably from 0.1 to 5% by weight and more preferably from 0.1 to 1% by weight, based on the polycondensate.

It is possible to add to the inventive melt compounding further ingredients which are known to those skilled in the art but are not essential to the invention, for example the additives customary in plastics technology, such as stabilizers, neutralizing agents, lubricants and mold-release agents, antiblocking agents, dyes or fillers. Useful stabilizers include, for example, antioxidants such as sterically hindered phenols. This allows further oxidative degradation of the polycondensates to be counteracted.

The inventive biodegradable polyester mixtures can be prepared from the individual components by known processes (EP 792 309 and U.S. Pat. No. 5,883,199).

For example, all components i, ii and the compatibilizer can be mixed and reacted in one process step in the mixing apparatus known to those skilled in the art, for example kneaders or extruders, at elevated temperatures, for example from 120 to 220° C.

With the aid of the process according to the invention, biodegradable polymer mixtures are obtained which can be processed without any problems (with stable bubbles) to give puncture-resistant films.

### EXAMPLES

### Performance Tests

The molecular weight Mₙ of the partly aromatic polyester was determined as follows:

15 mg of the partly aromatic polyester were dissolved in 10 ml of hexafluoroisopropanol (HFIP). In each case 125 μl of this solution were analyzed by means of gel permeation chromatography (GPC). The measurements were carried out at room temperature. For the elution, HFIP+0.05% by weight of potassium trifluoroacetate was used. The elution rate was 0.5 ml/min. The following column combination was used (all columns manufactured by Showa Denko Ltd., Japan): Shodex® HFIP-800P (diameter 8 mm, length 5 cm), Shodex® HFIP-803 (diameter 8 mm, length 30 cm), Shodex® HFIP-803 (diameter 8 mm, length 30 cm). The partly aromatic polyesters were detected by means of an RI detector (differential refractometry). The calibration was effected with narrow-range polymethyl methacrylate standards having molecular weights of from Mₙ=505 to Mₙ=2 740 000. Outside this interval, the elution ranges were determined by extrapolation.

The melting points of the partly aromatic polyesters were determined by DSC measurements with an Exstet DSC 6200R unit from Seiko:

from 10 to 15 mg of the particular samples were heated from −70° C. to 200° C. at a heating rate of 20° C./min under a nitrogen atmosphere. The melting points of the samples reported were the peak temperatures of the melting peaks observed. The reference used was in each case an empty sample crucible.

The homogeneity of the mixtures of components i, ii and compatibilizer, and also the mixtures prepared for comparison, was determined by pressing these mixtures at 190° C. in each case to give films having a thickness of 30 μm. The fraction of undispersed components ii in these films was assessed visually.

### Feedstocks:

### Component i:

i-1: To prepare the polyester i-1, 87.3 kg of dimethyl terephthalate, 80.3 kg of adipic acid, 117 kg of 1,4-butanediol and 0.2 kg of glycerol were mixed together with 0.028 kg of tetrabutyl orthotitanate (TBOT), and the molar ratio between alcohol components and acid component was 1.30. The reaction mixture was heated to a temperature of 180° C. and reacted at this temperature for 6 h. Subsequently, the temperature was increased to 240° C. and the excess dihydroxyl compound was distilled off under reduced pressure over a period of 3 h. Subsequently, 0.9 kg of hexamethylene diisocyanate was metered in slowly at 240° C. within 1 h.
The thus obtained polyester i-1 had a melting point of 119° C. and a molecular weight (Mₙ) of 23 000 g/mol.

### Component ii:

ii-1: PHB/V_{(3%)} (Enmat®)

### Compatibilizer:

Joncryl® ADR 4368 from Johnson Polymer.
ESBO: epoxidized soybean oil (e.g. Merginat® ESBO from Hobum, Hamburg, or Edenol® B 316 from Cognis, Dusseldorf).

### Examples 1 to 4

Blends (mixtures) of 60% by weight of Ecoflex® and 40% by weight of PHBN (3%) Enmat® were investigated:

Procedure of the experiments:

The polymer (Ecoflex-Enmat blend) was weighed into a glass vessel on an analytical balance. Subsequently, the compatibilizer (and additionally a stabilizer in the stabilization experiments) and then the activator were added in the middle. In the comparative example, the compounding was conducted without activator or only with stabilizer.

Catalysts which were present in liquid form were added dropwise only shortly before the charging procedure. The mixture was charged into the funnel of our cylindrical charging attachment and introduced into the extruder by means of the die in the cylinder. The melt circulated for 3 min in the circuit and was then discharged from the extruder.

Temp.: 170-171° C., rotation rate: 80 rpm, residence time: 3 min, weight: 17 g (mixtures of polymer/compatibilizer, polymer/compatibilizer/activator, polymer/stabilizer, polymer/compatibilizer/activator/stabilizer)

MVR measurement: 170° C./2.16 kg

| | | | | | Flow rate |
|---|---|---|---|---|---|
| | | | | | MVR |
| | Polycondensate | Compatibilizer | Activator | Stabilizer | [cm³/10 min] |
| Example | [% by wt.] | [% by wt.] | [% by wt.] | [% by wt.] | 170° C./2.16 kg |
| Comp. | 99 | 1 | — | — | 51.4 |
| Ex. 1 | (Ecoflex F/ | (Joncryl ® | | | |
| | Enmat- Blend) | ADR 4368) | | | |
| Ex. 2 | 98.5 | 1 | 0.5 | — | 20.1 |
| | | | Zinc stearate | | |
| Ex. 3 | 97.5 | 1 | 0.5 | 1 | 20.0 |
| | | | Zinc stearate | Irganox 1010 | |
| Ex. 4 | 98.5 | 1 | 0.5 | — | 29.2 |
| | | | Tetrabutyl | | |
| | | | o-titanate | | |
| Ex. 5 | 98.5 | 1 | 0.5 | — | 18.0 |
| | | | Ethyltriphenyl- | | |
| | | | phosphonium | | |
| | | | bromide | | |
| Ex. 6 | 94.5 | 5 | 0.5 | | 39.3 |
| | | (Merginate ®) | Zinc stearate | | |
| Ex. 7 | 98.5 | 1 | 0.5 | — | 31.0 |
| | | (Epikote ® 828) | Zinc stearate | | |

Examples 2 to 7 which also comprise an activator in addition to the compatibilizer exhibit a distinctly lower flow rate (MVR) than comparative example 1 which does comprise a compatibilizer but no activator.

1-10. (canceled)

11. A process for compounding polycondensates selected from the group consisting of polyamide, polyester and polycarbonate, in the presence of an oligomeric or polymeric epoxidized compound, of a bisphenol A epoxide or of an epoxy-containing natural oil or fatty acid ester, which comprises carrying out the compounding at temperatures less than/equal to 220° C. and in the presence of an activator selected from the group consisting of: zinc, titanium compound and C₁-C₁₂-alkyltriphenylphosphonium halide.

12. The process according to claim 11, wherein the polycondensate is one or more biodegradable homo- or copolyesters selected from the group consisting of polylactide, polycaprolactone, polyhydroxyalkanoates and polyesters composed of aliphatic and/or aromatic dicarboxylic acids and aliphatic diols.

13. The process according to claim 11, wherein the polycondensate is one or more biodegradable homo- or copolyesters selected from the group consisting of polylactide, poly-β-hydroxybutyrate, poly-β-hydroxybutyrate coalkanoate and polyester, the polyester having the following composition:
A) an acid component composed of
a1) from 30 to 99 mol % of at least one aliphatic or of at least one cycloaliphatic dicarboxylic acid or their ester-forming derivatives or mixtures thereof,
a2) from 1 to 70 mol % of at least one aromatic dicarboxylic acid or its ester-forming derivative or mixtures thereof and
a3) from 0 to 5 mol % of a sulfonate-containing compound, the molar percentages of components a1) to a3) together adding up to 100%, and
B) a diol component composed of at least one C₂— to —C₁₋₂-alkanediol or a C₅— to —C₁₋₁₀-cycloalkanediol or mixtures thereof and, if desired, additionally one or more components selected from
C) a component selected from
c1) dihydroxyl compound which comprises at least one ether function and is of the formula I
HO—[(CH₂)ₙ—O]ₘ—H (I)
in which n is 2, 3 or 4 and m is an integer from 2 to 250,
c2) at least one hydroxy carboxylic acid of the formula IIa or IIb 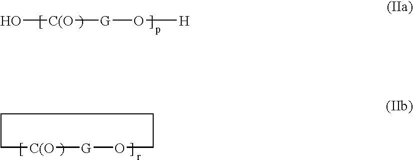
in which p is an integer from 1 to 1500 and r is an integer from 1 to 4, and G is a radical which is selected from the group consisting of phenylene, —(CH₂)_{q}—, where q is an integer from 1 to 5, —C(R)H— and —C(R)HCH₂, where R is methyl or ethyl,
c3) at least one amino-C₂— to —C₁₋₂-alkanol or at least one amino-C₅— to —C₁₋₁₀-cycloalkanol or mixtures thereof,
c4) at least one diamino-C₁- to —C₈-alkane,
c5) at least one 2,2′-bisoxazoline of the general formula III 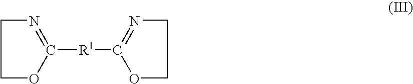
where R¹ is a single bond, a (CH₂)_{z}-alkylene group where z=2, 3 or 4, or a phenylene group,
c6) at least one aminocarboxylic acid selected from the group consisting of the natural amino acids, polyamides obtainable by polycondensation of a dicarboxylic acid having from 4 to 6 carbon atoms and a diamine having from 4 to 10 carbon atoms, compounds of the formulae IVa and IVb 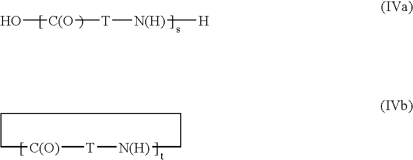
in which s is an integer from 1 to 1500 and t is an integer from 1 to 4, and T is a radical which is selected from the group consisting of phenylene, —(CH₂)ᵤ—, where u is an integer from 1 to 12, —C(R²)H— and —C(R²)HCH₂, where R² is methyl or ethyl,
and polyoxazolines having the repeat unit V 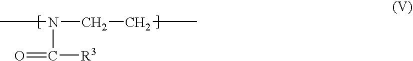
in which R³ is hydrogen, C₁-C₆-alkyl, C₅-C₈-cycloalkyl, phenyl which is unsubstituted or up to trisubstituted by C₁-C₄-alkyl groups, or tetrahydrofuryl, or mixtures of c1) to c6)
and
D) a component selected from
d1) at least one compound having at least three groups capable of ester formation,
d2) at least one isocyanate,
d3) at least one divinyl ether,
or mixtures of d1) to d3).

14. The process according to claim 11, wherein the oligomeric or polymeric epoxidized compound is a copolymer composed of styrene and glycidyl(meth)acrylates.

15. The process according to claim 11, wherein the epoxy-containing natural oil is epoxidized olive oil, linseed oil, soybean oil, palm oil, peanut oil, coconut oil, seaweed oil, fish oil or a mixture of these compounds.

16. The process according to claim 11, wherein the oligomeric or polymeric epoxidized compound, the epoxy-containing natural oil or the fatty acid ester is used in a concentration of from 0.1 to 2% by weight based on the polycondensate.

17. The process according to claim 11, wherein the activator is used in a concentration of from 0.3 to 5% by weight based on the polycondensate.

18. The process according to claim 11, wherein the activator used is tetra-C₁-C₆-alkyl o-titanate.

19. The process according to claim 11, wherein the activator used is zinc stearate.

20. The process according to claim 11, wherein the activator used is ethyltriphenylphosphonium bromide.

21. The process according to claim 13, wherein the oligomeric or polymeric epoxidized compound is a copolymer composed of styrene and glycidyl(meth)acrylates.

22. The process according to claim 13, wherein the epoxy-containing natural oil is epoxidized olive oil, linseed oil, soybean oil, palm oil, peanut oil, coconut oil, seaweed oil, fish oil or a mixture of these compounds.

23. The process according to claim 13, wherein the oligomeric or polymeric epoxidized compound, the epoxy-containing natural oil or the fatty acid ester is used in a concentration of from 0.1 to 2% by weight based on the polycondensate.

24. The process according to claim 13, wherein the activator is used in a concentration of from 0.3 to 5% by weight based on the polycondensate.

25. The process according to claim 13, wherein the activator used is tetra-C₁-C₆-alkyl o-titanate.

26. The process according to claim 13, wherein the activator used is zinc stearate.

27. The process according to claim 13, wherein the activator used is ethyltriphenylphosphonium bromide.

28. The process according to claim 15, wherein the oligomeric or polymeric epoxidized compound, the epoxy-containing natural oil or the fatty acid ester is used in a concentration of from 0.1 to 2% by weight based on the polycondensate.

29. The process according to claim 16, wherein the activator is used in a concentration of from 0.3 to 5% by weight based on the polycondensate.

30. The process according to claim 16, wherein the activator used is ethyltriphenylphosphonium bromide.
